(19) United States
(12) Patent Application Publication
(10) Pub. No.: US 2013/0206681 A1
(43) Pub. Date: Aug. 15, 2013

(54) Interlocking Frame Assembly System and Method

(71) Applicants: Glenn David Alexander, Dunedin (NZ); Joseph A. Salpietra, Jr., Shreveport, LA (US)

(72) Inventors: Glenn David Alexander, Dunedin (NZ); Joseph A. Salpietra, Jr., Shreveport, LA (US)

(21) Appl. No.: 13/757,355

(22) Filed: Feb. 1, 2013

Related U.S. Application Data
(60) Provisional application No. 61/594,692, filed on Feb. 3, 2012.

(51) Int. Cl. B01D 29/05; B01D 29/01

(52) U.S. Cl. CPC B01D 29/05; B01D 29/012
USPC 210/483; 29/428

(57) ABSTRACT

A filter assembly comprises a frame and a filter media formed over the frame. The frame comprises a first frame component comprising a particular first end portion, and a second frame component comprising a certain first end portion. The particular first end portion of the first frame component interlocks with the certain first end portion of the second frame component. A filter assembly method comprises forming a frame by interlocking a particular first end of a first frame component with a certain first end of a second frame component, and forming filter media over the frame.

### BACKGROUND

The present disclosure relates generally to filter media and supporting apparatus for filtering out grease, fat, other related particles, or any combination thereof; and, more specifically, to filter assemblies and methods.

### BRIEF SUMMARY

A filter assembly comprises a frame and a filter media formed over the frame. The frame comprises a first frame component comprising a particular first end portion, and a second frame component comprising a certain first end portion. The particular first end portion of the first frame component interlocks with the certain first end portion of the second frame component. A filter assembly method comprises forming a frame by interlocking a particular first end of a first frame component with a certain first end of a second frame component, and forming filter media over the frame.

Other objects, features, and advantages of the present invention will be apparent to persons of ordinary skill in the art in view of the foregoing detailed description of the invention and the accompanying drawings.

### BRIEF DESCRIPTION OF THE DRAWINGS

For a more complete understanding of the present invention, needs satisfied thereby, and the objects, features, and advantages thereof, reference now is made to the following description taken in connection with the accompanying drawings.

FIG. 1 illustrates interlocking frame components in accordance with particular embodiments of the present disclosure;

FIG. 2 illustrates an assembled frame formed from the interlocking frame components shown in FIG. 1, in accordance with particular embodiments of the present disclosure;

FIG. 3 illustrates a perspective view of an assembled frame shown in FIG. 2 with laminate strips, in accordance with particular embodiments of the present disclosure;

FIG. 4 illustrates a filter assembly with a frame and filter material in accordance with particular embodiments of the present disclosure; and

FIG. 5 illustrates an assembly machine used to form the frame and filter assembly, in accordance with particular embodiments of the present disclosure.

### DETAILED DESCRIPTION

Processes and designs for frame construction may involve the assembly of strips of various width of flame resistant cardboard or similar material. This material may be formed into a frame by gluing the strips with an overlapping joint and heat-resistant or PVA glue. This process, while making a strong frame ideally suited to support a filter media, may have two primary drawbacks: (1) an impairment of automated assembly; and (2) freight volume.

In automated assembly processes, the frame may be assembled, glued and dried quickly so that the filter media may be applied to a strong frame. Failure to have a strong frame may result in a frame that cannot support the filter media as assembled. Because the filter may be made from natural fibers and may be designed to be biodegradable, it may not be possible to use non-biodegradeable components, such as conventional fasteners (e.g., staples, clips, or nails) to either permanently or temporally fix the strips in place. Other fastening systems, such as hot melt glue which dries rapidly to form a strong bond, may be flammable and, therefore, may not be suitable for use in certain applications. Accordingly, the drying time of the PVA glue (or similar type of glue, adhesive, or the like) may be a limiting factor in any automated process to manufacture a disposable filter.

A method of producing the filters may result in a finished filter assembly having a minimum thickness of, for example, 8 mm (2×4 mm) for the frame (i.e., 8 mm is twice the thickness of the frame components which are overlayed). Accordingly, the volume for freight may be double what it would be if only the 4 mm thickness of the frame components are used. This increased freight volume may increase costs for a disposable filter.

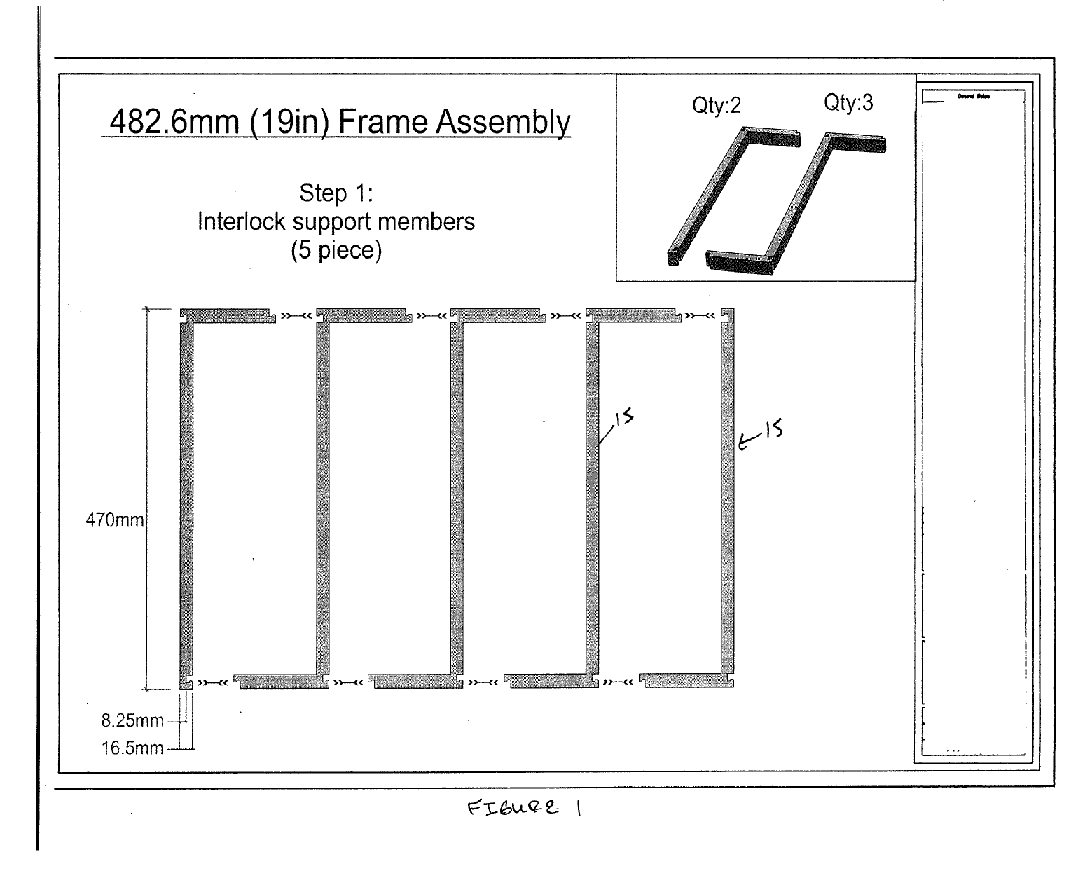

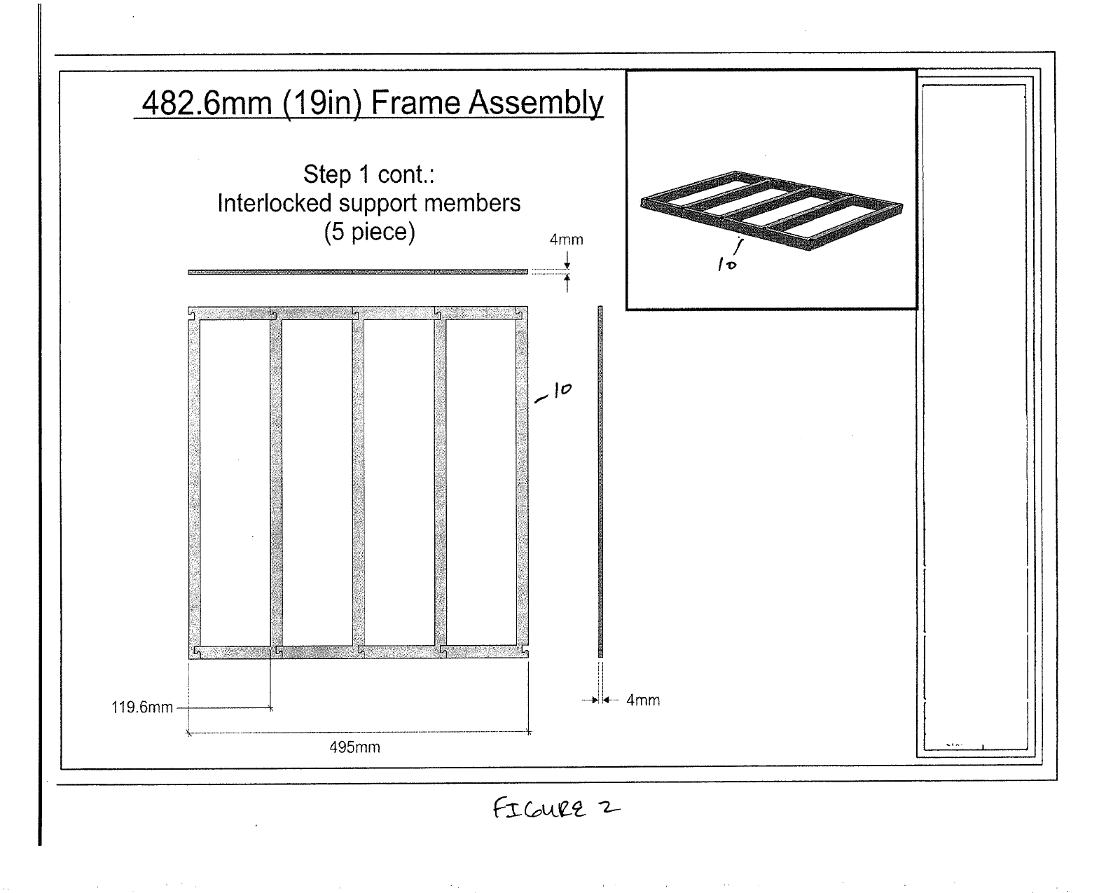

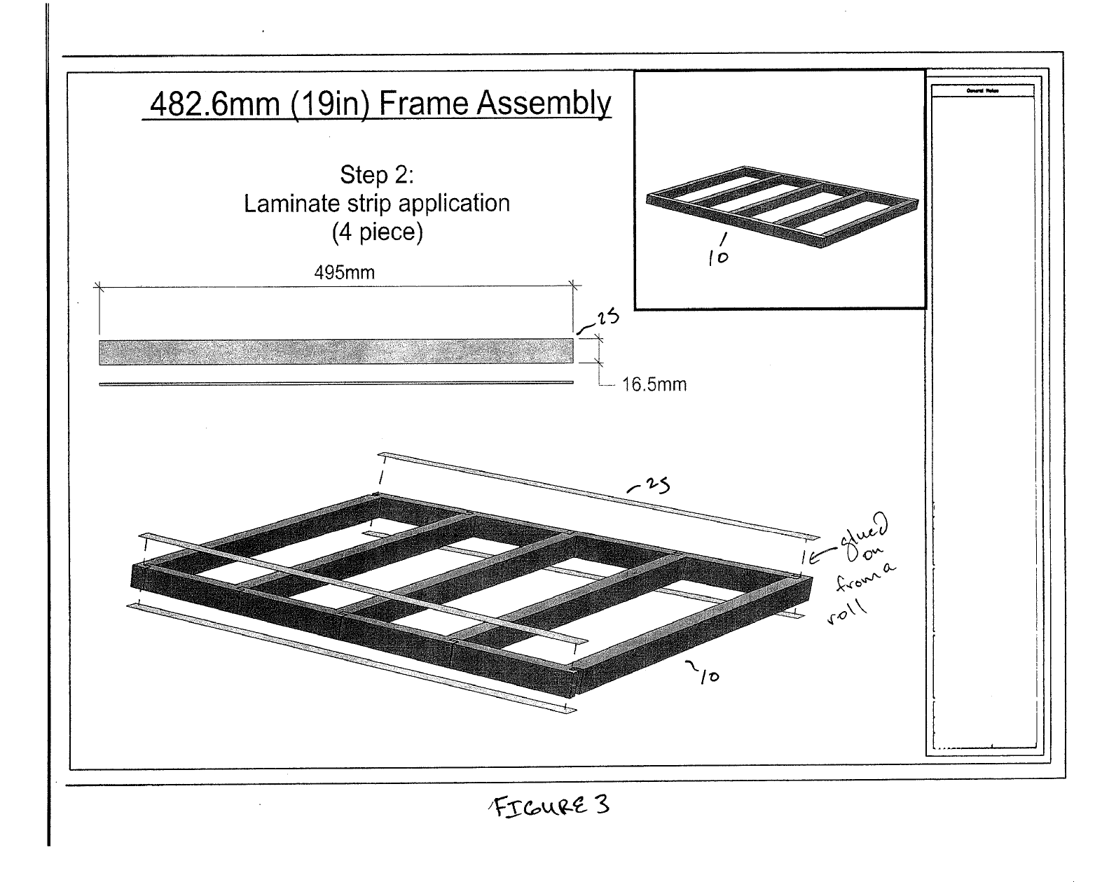

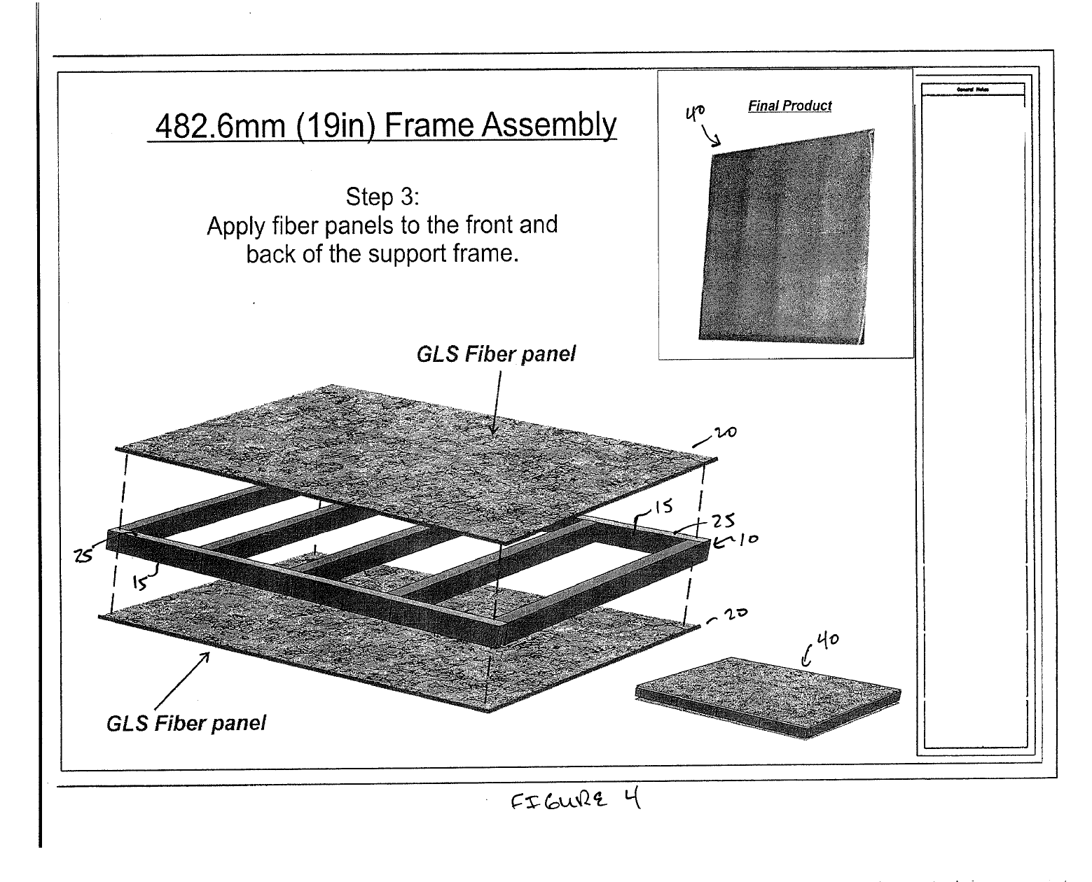

Therefore, a need has arisen for filter assemblies and methods that provide sufficient strength at a reduced volume and/or weight. A solution to this issue has been the innovative interlocking frame 10 with laminate support, as shown in FIGS. 1-4. In certain embodiments, frame 10 may be manufactured by die cutting Z-shaped and L-shaped frame components 15 out of a sheet of a constituent material (e.g., flame resistant cardboard or the like). As shown in FIGS. 1-4, frame 10 may have a unique interlocking shape with corresponding male and female portions. It should be understood that any appropriate interlocking shape may be formed on the ends of the Z-Shaped and/or L-shaped frame components. The Z-shaped and/or L-shaped frame components 15 may be assembled with the interlocking ends mated to hold the frame components 15 together to form a frame of, for example, approximately 4 mm in thickness. For example, two L-shaped and three Z-shaped frame components 15 may be joined to form a frame. In some embodiments, five Z-shaped frame components 15 may be used by trimming the excess ends off two Z-shaped frame components 15 to make the L-shaped frame components 15.

A first end of a frame component may include a male interlock portion and a second end of that frame component may include a female interlock portion. Further, a first end of another frame component may include a female interlock portion that corresponds to the male interlock portion and a second end of the another frame component may include a male interlock portion that corresponds to the female interlock portion. Accordingly, each of the first ends and the second ends of the two frame components may be interlocked, respectively. The interlocking nature of the design gives frame 10 enough strength to allow automated manufacture before the adhesive may dry fully. Additionally, filter media 20 may be adhered to the interlocking frame in such a process.

In some embodiments, to add additional strength, four (4) laminate strips 25, each, for example, approximately 0.5 mm thick and having a width approximately equal to the width of frame components 15 may be adhered to either side of the top and base section of the frame. Laminate strips 25, so applied, may add strength since they may reinforce the interlocking joints of frame components 15.

As a result, a frame 10 so assembled may have a thickness of, for example, approximately 4 mm, or half of a frame conventionally assembled as described above, if no laminate strips are added. A frame 10 assembled with laminate strips 25 may have a thickness of, for example, approximately 5 mm.

The design of frame 10 allows automated manufacture and has a significantly reduced volume, which may result in freight savings of, for example, approximately 35-50%.

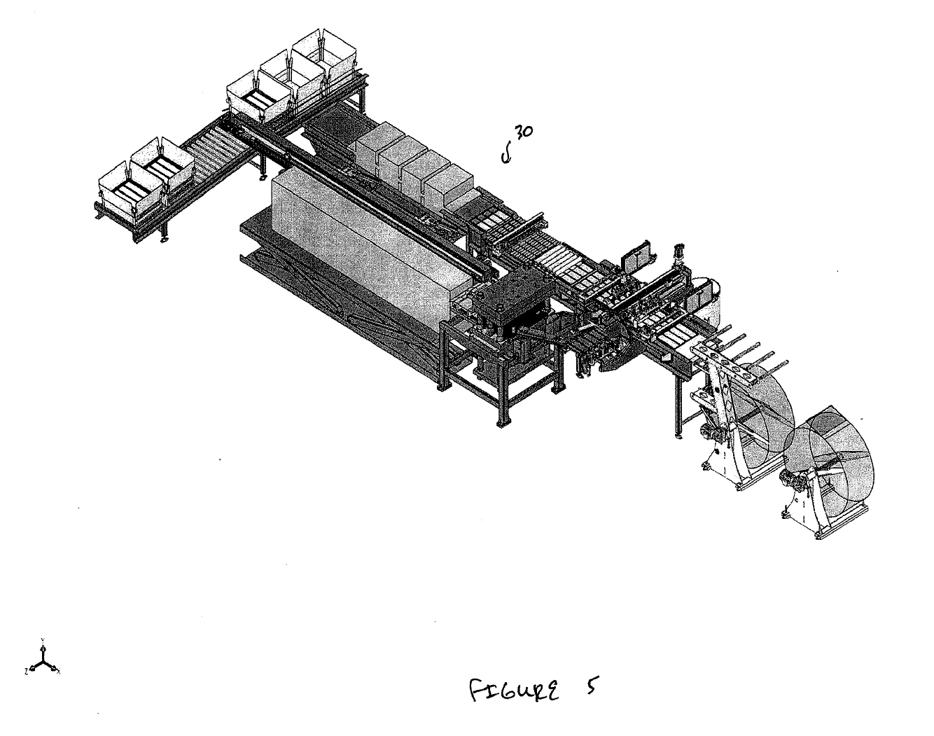

In accordance with the design and process of forming frame 10, a purpose designed assembly machine 30 may be provided, as shown in FIG. 5. The operation of assembly machine 30 now is described in more detail.

The Z-shaped and/or L-shaped frame components 15 may be die-cut. A flame resistant board may be cut to the desired width (e.g., 455 mm) to make a Z-shaped frame component 15 for a particular size filter. The board may stacked in a de-stacker that can hold, for example, up to 300 sheets of 455 mm×3050 mm size sheets. The sheets may be fed through a press and the Z-shaped and/or L-shaped frame component 15 may be cut out of the sheet. Die-cutting this type of material presents technical challenges. Extremely high clamping pressures may be used to facilitate holding the board in place during the cutting process. In some embodiments, a hydraulic press may be used, which may be able to deliver approximately 300 tons pressure to the die.

The Z-shaped and/or L-shaped die-cut parts then may be taken out of the press, for example, by a robot and placed in the assembly station. Five Z-shaped frame component 15 pieces may be placed in the assembly station and the interlocking joints may be pressed in place. The two Z-shaped frame components on the end then may have one end of the “Z” removed with a cutting blade, thereby forming two L-shaped frame components 15. The frame components 15 then may be picked up and delivered to the assembly line at which the formed Z-shaped and L-shaped frame components 15, laminate strips 25, and filter media 20 may be assembled.

The assembly section may include: (1) two feed rollers with, for example, 300 m of filter media; (2) a conveyor line; (3) an automated PVA glue (or alternate adhesive) spray system; (4) a cross cutter; (5) a microwave dryer (or alternate drying means); and (6) a carton packing unit. The line may start with one filter media roll that may feed the bottom layer of filter media. The other filter media roll may feed the top layer of filter media. The bottom filter media layer may travel along a conveyor and glue, adhesive, or the like may be applied to the media on positions or portions where laminate strips 25 will be placed. Laminate strips 25 may be fed from a cassette that may place strips 25 onto the bottom layer at the appropriate position(s). Spray guns or mechanisms then may apply the adhesive (e.g., PVA glue or the like) to the filter media 20 at positions or portions where the assembled frame 10 will be placed. The assembled frame 10 then may be placed on the bottom layer, on top of the laminates and glued filter media.

The same process may be completed for the top with glue being applied to the top of the assembled frame components 15 and laminate strips 25, and the top layer of filter media 20 being adhered thereto. Accordingly, a filter 40 may comprise the assembled frame 10 and top and bottom filter media 20 in a continuous sandwich construction.

The continuous layer then may move to a cut-and-roll station at which filter 40 may be rolled on top and bottom to seal the edges and then may be cut by a cross cut knife to form the final filter assembly. Filter 40 then may pass through, for example, a continuous tunnel microwave dryer. Using the microwave dryer may be necessary for drying to occur at the desired rate, whereas conventional, convection, and/or radiant dryers may not allow for a desired drying rate to be achieved in certain embodiments, when filter media 20 has a high percentage of wool and acts as a very effective insulating layer that decreases the rate of heat transfer.

The completed dry filter may be dropped into a carton, inside a plastic liner bag, which may hold, for example, 20 filters per carton. A fragrance sachet also may be added to the carton to provide a pleasant aroma. The automated assembly may be able to produce a minimum of, for example, 180 filters per hour or 3 filters per minute on a continuous basis.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

What is claimed is:

1. A filter assembly comprising:
a frame comprising:
a first frame component comprising a particular first end portion,
a second frame component comprising a certain first end portion,
wherein the particular first end portion of the first frame component interlocks with the certain first end portion of the second frame component; and
filter media formed over the frame.

2. The filter assembly of claim 1, further comprising a laminate strip attached to the frame, wherein the filter media is formed over the frame and the laminate strip.

3. The filter assembly of claim 1, wherein the first frame component has a Z-shape and the second frame component has an L-shape.

4. The filter assembly of claim 1, wherein the filter media comprises a top layer and a bottom layer, each of the top layer and bottom layer being attached to the frame.

5. The filter assembly of claim 1, wherein one of the particular first end portion of the first frame component and the certain first end portion of the second frame component comprises a male interlock portion and the other of the particular first end portion of the first frame component and the certain first end portion of the second frame component comprises a female interlock portion that corresponds to the male interlock portion.

6. The filter assembly of claim 1, wherein the first frame component comprises a particular second end portion and the second frame component comprises a certain second end portion; and
wherein the particular second end portion of the first frame component interlocks with the certain second end portion of the second frame component.

7. The filter assembly of claim 6, wherein one of the particular second end portion of the first frame component and the certain second end portion of the second frame component comprises a male interlock portion and the other of the particular second end portion of the first frame component and the certain second end portion of the second frame component comprises a female interlock portion that corresponds to the male interlock portion.

8. A method comprising:
forming a frame by interlocking a particular first end of a first frame component with a certain first end of a second frame component; and
forming filter media over the frame.

9. The method of claim 8, further comprising attaching a laminate strip to the formed frame, wherein forming filter media over the frame comprises forming the filter media over the frame and the laminate strip.

10. The method of claim 8, wherein the first frame component has a Z-shape and the second frame component has an L-shape.

11. The method of claim 8, further comprising attaching a top layer of filter media to a top portion of the frame and attaching a bottom layer of filter media to a bottom portion of the frame.

12. The method of claim 11, wherein attaching the top layer of filter media and the bottom layer of filter media comprises applying an adhesive to each of the top layer of filter media and the bottom layer of filter media, and drying the filter media attached to the frame with a microwave dryer.

13. The method of claim 8, wherein forming the frame further comprises:
interlocking a male interlock portion of one of the particular first end portion of the first frame component and the certain first end portion of the second frame component with a female interlock portion of the other of the particular first end portion of the first frame component and the certain first end portion of the second frame component,
wherein the female interlock portion corresponds to the male interlock portion.

14. The method of claim 8, wherein forming the frame further comprises:
interlocking a particular second end portion of the first frame component with a certain second end portion of the second frame component.

15. The method of claim 14, wherein forming the frame further comprises:
interlocking a male interlock portion of one of the particular second end portion of the first frame component and the certain second end portion of the second frame component with a female interlock portion of the other of the particular second end portion of the first frame component and the certain second end portion of the second frame component,
wherein the female interlock portion corresponds to the male interlock portion.
